(19) United States
(12) Patent Application Publication
(10) Pub. No.: US 2025/0280002 A1
(43) Pub. Date: Sep. 4, 2025

(54) COMMUNICATION CONTROL SYSTEM, GATEWAY, AND COMMUNICATION CONTROL METHOD

(71) Applicant: NIPPON TELEGRAPH AND TELEPHONE CORPORATION, Tokyo (JP)

(72) Inventors: Yuki YAMANAKA, Tokyo (JP); Hiroyoshi TAKIGUCHI, Tokyo (JP); Masanori SHINOHARA, Tokyo (JP); Takuya MINAMI, Tokyo (JP); Yasunori WADA, Tokyo (JP); Yo KANEMOTO, Tokyo (JP); Hiroto NOMURA, Tokyo (JP)

(73) Assignee: NIPPON TELEGRAPH AND TELEPHONE CORPORATION, Tokyo (JP)

(21) Appl. No.: 19/203,157

(22) Filed: May 8, 2025

Related U.S. Application Data
(63) Continuation of application No. PCT/JP2022/042443, filed on Nov. 15, 2022.

(51) Int. Cl. H04L 9/40; H04L 12/66; H04L 67/12

(52) U.S. Cl. CPC H04L 63/101; H04L 12/66; H04L 67/12

(57) ABSTRACT

A communication control system includes a gateway and an IoT device connected to the gateway, wherein the gateway includes a request module configured to request, from the IoT device, information regarding normal communication performed by the IoT device, and a creation module configured to create a whitelist in which details of communication permitted for each IoT device are designated on a basis of the information regarding normal communication performed by the IoT device, which is transmitted from the IoT device, and the IoT device includes a transmission module configured to transmit the information regarding normal communication performed by the IoT device to the gateway in response to a request from the request module.

### TECHNICAL FIELD

The present invention relates to a communication control system, a gateway, and a communication control method.

### BACKGROUND ART

As the risk of cyberattacks has increased in recent years, there has been a growing demand for precise access control using whitelists to protect vulnerable devices such as Internet of Things (IoT) devices from cyberattacks, including zero-day attacks, and efforts are being made to automatically generate whitelists for IoT devices and the like (see NPL 1).

### CITATION LIST

### Non Patent Literature

[NPL 1] Automatic generation and validation of controller whitelists (https://www.jstage.jst.go.jp/article/sicejl/60/1/60_21/_article/-char/ja/)
[NPL 2] Permissions on Android (https://developer.android.com/guide/topics/permissions/overview)

### Technical Problem

However, these efforts mainly involve generating whitelists afterwards from the normal state of already completed devices or apps, or blindly trusting and using whitelists defined by the manufacturer, and it is not possible for a third party to verify the accuracy of the whitelists.

Meanwhile, in recent years, attention has been focused on mechanisms that allow a third party to check whether purchased apps or devices have unnecessary permissions or engage in unnecessary communications unintended by a user (see NPL 2).

The present invention has been made in consideration of the above, and an object of the present invention is to provide a communication control system, a gateway, and a communication control method that allow a third party to check whether or not unnecessary communications unintended by a user are being performed.

### Solution to Problem

In order to solve the above-mentioned problems and achieve the object, according to the present invention, there is provided a communication control system including a gateway and an IoT device connected to the gateway, wherein the gateway includes a request module configured to request, from the IoT device, information regarding normal communication performed by the IoT device, and a creation module configured to create a whitelist in which details of communication permitted for each IoT device are designated on a basis of the information regarding normal communication performed by the IoT device, which is transmitted from the IoT device, and the IoT device includes a transmission module configured to transmit the information regarding normal communication performed by the IoT device to the gateway in response to a request from the request module.

### Advantageous Effects of Invention

According to the present invention, it is possible for a third party to verify whether or not communications that are inconvenient for a user are being performed.

### BRIEF DESCRIPTION OF DRAWINGS

FIG. 1 is a block diagram illustrating an example of a configuration of a communication control system.

FIG. 2 is a block diagram illustrating an example of a configuration of a gateway.

FIG. 3 is a block diagram illustrating an example of a configuration of an IoT device.

FIG. 4 is a diagram for describing an overview of processing of the communication control system.

FIG. 5 is a diagram showing an example of information that defines normal communication performed by the IoT device.

FIG. 6 is a flowchart showing an example of a flow of processing performed by the communication control system.

### DESCRIPTION OF EMBODIMENTS

Hereinafter, embodiments of a communication control system, a gateway, and a communication control method according to the present application will be described in detail with reference to the drawings. The present invention is not limited to the present embodiment. In addition, in the drawings, the same parts are denoted by the same reference numerals, and duplicate descriptions will be omitted.

### [Overview of Present Invention]

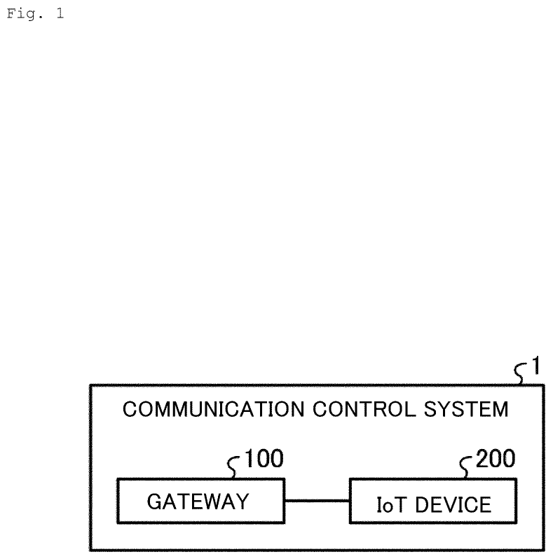

In a communication control system 1 according to the present embodiment, a gateway 100 creates a whitelist on the basis of information regarding normal communication performed by an IoT device 200, thereby enabling verification as to whether or not communications that are inconvenient for a user of the IoT device 200 are being performed.

[Configuration of Communication Control System] First, the configuration of the communication control device will be described with reference to FIG. 1. As illustrated in FIG. 1, the communication control system 1 includes a gateway 100 and an IoT device 200. The gateway 100 accommodates the IoT device 200 and creates a whitelist on the basis of information regarding normal communication performed by the IoT device 200, such as an NSTO.

Here, a Network Secure Transparency Object (NSTO) is information regarding normal communication performed by the IoT device 200. The NSTO includes information such as, for example, a device ID, an IP address, a MAC address, a communication ID, a protocol, a port number, a destination, content included, encoding, a communication ID that should exist beforehand, a communication ID that should exist immediately beforehand, a communication ID that should exist afterward, and a communication ID that should exist immediately afterward.

The NSTO is defined by the manufacturer or the like of the IoT device 200 and checked by the user. For example, the NSTO is distributed in a form attached to the IoT device 200, and the user verifies the NSTO by visual inspection or the like to check whether or not unnecessary communication is permitted. The NSTO format may be, for example, json, yaml, or xml.

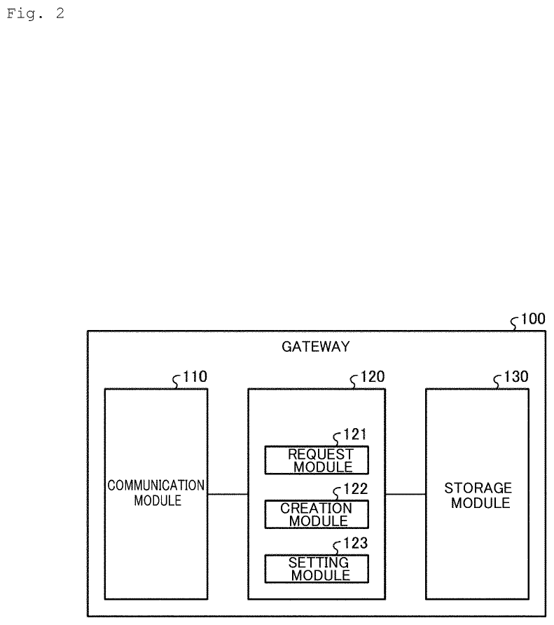

The IoT device 200 is a device compatible with an NSTO or a terminal on which a predetermined application is installed. The IoT device 200 transmits information regarding normal communication performed by itself to the gateway 100.

[Configuration of Gateway] Next, the configuration of the gateway 100 will be described with reference to FIG. 2. As illustrated in FIG. 2, the gateway 100 includes a communication module 110, a control module 120, and a storage module 130. Note that each of these modules may be distributed and held in the plurality of devices. The processing of each of these modules will be described below.

The communication module 110 is realized by a Network Interface Card (NIC) or the like, and enables communication between an external device and the control module 120 via a telecommunication line such as a Local Area Network (LAN) or the Internet. For example, the communication module 110 enables the communication between the external device and the control module 120.

The storage module 130 is realized by, for example, a semiconductor memory element such as a Random Access Memory (RAM) or a Flash Memory, or a storage device such as a hard disk or an optical disc. The information stored in the storage module 130 includes for example, an NSTO, a device ID, an IP address, a MAC address, a communication ID, a protocol, a port number, a destination, content included, encoding, a communication ID that should exist beforehand, a communication ID that should exist immediately beforehand, a communication ID that should exist afterward, a communication ID that should exist immediately afterward, and other information necessary for selection in communication control. Note that, the information stored in the storage module 130 is not limited to the above description.

The control module 120 is realized using a Central Processing Unit (CPU), a Network Processor (NP), a Field Programmable Gate Array (FPGA), or the like, and executes a processing program stored in a memory. As illustrated in FIG. 2, the control module 120 includes a request module 121, a creation module 122, and a setting module 123. Hereinafter, each module of the control module 120 will be described.

The request module 121 requests, from the IoT device 200, information regarding normal communication performed by the IoT device 200. For example, the request module 121 requests, from the IoT device 200, an NSTO as information regarding normal communication performed by the IoT device 200. To give a more specific example, the request module 121 requests information such as information such as a communication ID, a protocol, a port number, a destination, content included, encoding, a communication ID that should exist beforehand, a communication ID that should exist immediately beforehand, a communication ID that should exist afterward, and a communication ID that should exist immediately afterward.

Also, for example, upon receiving a request to start communication from a start request module 221 (described later), the request module 121 requests, from the IoT device 200, information regarding normal communication performed by the IoT device 200. For example, upon receiving a request to start communication from the start request module 221, the request module 121 requests, from the IoT device 200, transmission of an NSTO as information regarding normal communication performed by the IoT device 200. Also, for example, the request module 121 receives a packet conveying a request to start communication from the start request module 221, and transmits, to the IoT device 200, a packet conveying a request for information regarding normal communication performed by the IoT device 200.

The creation module 122 creates a whitelist in which details of communication permitted for each IoT device 200 are designated on the basis of information regarding normal communication performed by the IoT device 200 transmitted by the transmission module 222. For example, the creation module 122 creates a whitelist in which details of communication permitted for each IoT device 200 are designated on the basis of the NSTO transmitted by the transmission module 222.

To give a more specific example, the creation module 122 creates a whitelist for the IoT device 200 using information such as the communication ID, the protocol, the port number, the destination, the content included, the encoding, the communication ID that should exist beforehand, the communication ID that should exist immediately beforehand, the communication ID that should exist afterward, and the communication ID that should exist immediately afterward, which are transmitted from the IoT device 200. Accordingly, the creation module 122 creates a whitelist in which only communications that are defined based on information regarding normal communication performed by the IoT device 200 are permitted.

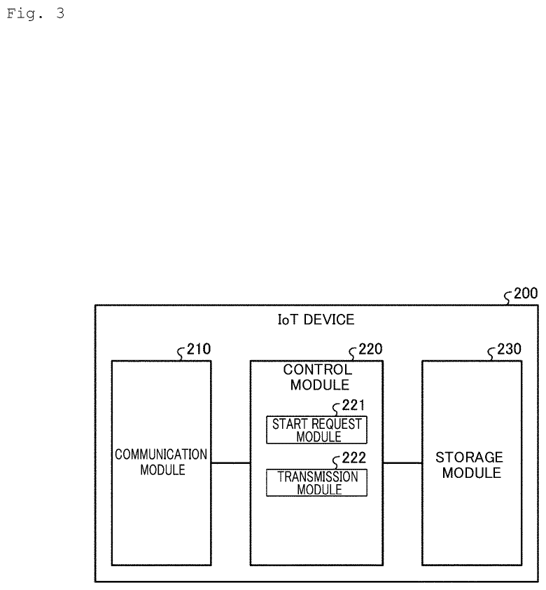

The setting module 123 sets the whitelist created by the creation module 122. For example, the setting module 123 sets the gateway 100 to permit only communications within the range described in the whitelist created by the creation module 122. At this time, the setting module 123 may notify the IoT device 200 that the whitelist has been set, at the same time as setting the whitelist created by the creation module 122.

[Configuration of IoT Device] Next, the configuration of the IoT device 200 will be described with reference to FIG. 3. As illustrated in FIG. 3, the IoT device 200 includes a communication module 210, a control module 220, and a storage module 230. Note that each of these modules may be distributed and held in the plurality of devices. The processing of each of these modules will be described below.

The communication module 210 is realized by a Network Interface Card (NIC) or the like, and enables communication between an external device and the control module 120 via a telecommunication line such as a Local Area Network (LAN) or the Internet. For example, the communication module 210 enables the communication between the external device and the control module 220.

The storage module 230 is realized by, for example, a semiconductor memory element such as a Random Access Memory (RAM) or a Flash Memory, or a storage device such as a hard disk or an optical disc. The information stored in the storage module 230 includes for example, an NSTO, a device ID, an IP address, a MAC address, a communication ID, a protocol, a port number, a destination, content included, encoding, a communication ID that should exist beforehand, a communication ID that should exist immediately beforehand, a communication ID that should exist afterward, a communication ID that should exist immediately afterward, and other information necessary for selection in communication control. Note that, the information stored in the storage module 230 is not limited to the above description.

The control module 220 is realized using a Central Processing Unit (CPU), a Network Processor (NP), a Field Programmable Gate Array (FPGA), or the like, and executes a processing program stored in a memory. As illustrated in FIG. 3, the control module 220 includes a start request module 221 and a transmission module 222. Hereinafter, each module of the control module 220 will be described.

The start request module 221 requests the gateway 100 to start communication. For example, the start request module 221 transmits a packet conveying a request to start communication to the gateway 100.

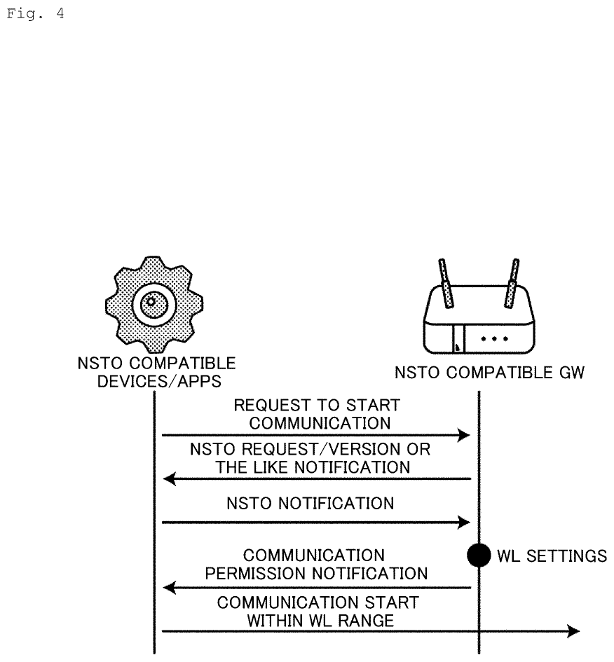

In response to a request from the request module 121, the transmission module 222 transmits information regarding normal communication performed by the IoT device 200 to the gateway 100. For example, in response to a request from the request module 121, the transmission module 222 transmits an NSTO as information regarding normal communication performed by the IoT device 200 to the gateway 100. To give a more specific example, in response to a request from the request module 121, the transmission module 222 transmits, to the gateway 100, information such as the communication ID, the protocol, the port number, the destination, the content included, the encoding, the communication ID that should exist beforehand, the communication ID that should exist immediately beforehand, the communication ID that should exist afterward, and the communication ID that should exist immediately afterward.

[Overview of Processing] Next, an overview of the processing performed by the communication control system 1 will be described with reference to FIG. 4. First, the start request module 221 of the IoT device 200 sends a request to start communication to the gateway 100. Next, upon receiving a request to start communication from the start request module 221, the gateway 100 requests, from the IoT device 200, information regarding normal communication performed by the IoT device 200. At this time, the gateway 100 may notify the IoT device 200 of version information and the like at the same time as requesting information regarding normal communication performed by the IoT device 200.

Then, upon receiving the request from the request module 121, the transmission module 222 of the IoT device 200 transmits information regarding normal communication performed by the IoT device 200 to the gateway 100. Thereafter, the creation module 122 of the gateway 100 creates a whitelist using information regarding normal communication performed by the IoT device 200. For example, the creation module 122 creates a whitelist in which details of communication permitted for each IoT device 200 are designated on the basis of the NSTO as information regarding normal communication performed by the IoT device 200 transmitted by the transmission module 222. Then, the setting module 123 sets the whitelist created by the creation module 122.

Accordingly, the communication control system 1 not only ensures that only communications intended by the manufacturer are performed through access control by the gateway 100 using information regarding normal communication performed by the IoT device 200, but also makes it possible to verify whether or not communications that are inconvenient for the user are being performed.

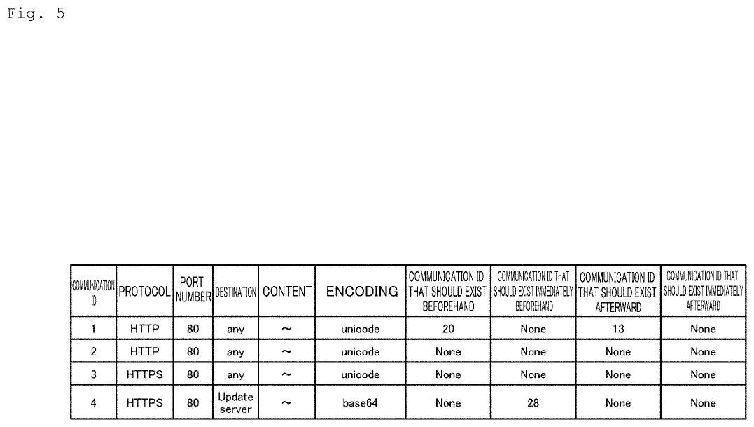

Next, information regarding normal communication performed by the IoT device 200 will be described with reference to FIG. 5. The information regarding normal communication performed by the IoT device 200 requested by the request module 121 of the gateway 100 includes information such as the communication ID, the protocol, the port number, the destination, the content, the encoding, the communication ID that should exist beforehand, the communication ID that should exist immediately beforehand, the communication ID that should exist afterward, and the communication ID that should exist immediately afterward. The details described in the content may differ depending on the type of protocol. For example, the details described in the content may be a set of regular expressions that a value in a certain field has to satisfy.

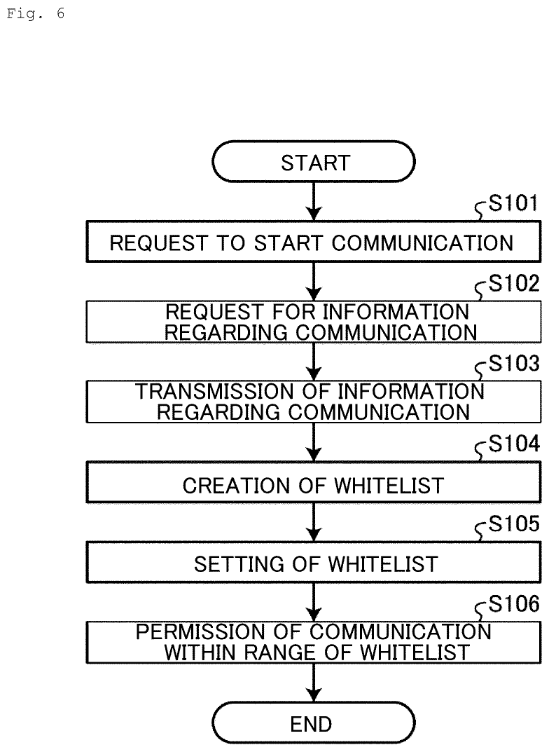

Thereby, the communication control system 1 makes it easy for a third party to examine the details of the communication performed by the IoT device 200.

[Flowchart] Next, the flow of processing performed by the gateway 100 will be described with reference to FIG. 6. Note that the following steps S101 to S106 may be executed in a different order. Furthermore, among the following steps S101 to S106, some processes may be omitted.

First, the start request module 221 of the IoT device 200 makes a request to start communication to the gateway 100 (step S101). For example, the start request module 221 of the IoT device 200 transmits a packet conveying a request to start communication to the gateway 100.

Next, upon receiving the request from the start request module 221, the request module 121 of the gateway 100 requests, from the IoT device 200, information regarding normal communication performed by the IoT device 200 (step S102). For example, the request module 121 of the gateway 100 requests, from the IoT device 200, transmission of an NSTO as information regarding normal communication performed by the IoT device 200.

Then, upon receiving the request from the request module 121, the transmission module 222 of the IoT device 200 transmits information regarding normal communication performed by the IoT device 200 to the gateway 100 (step S103). For example, upon receiving the request from the request module 121, the transmission module 222 of the IoT device 200 transmits an NSTO as information regarding normal communication performed by the IoT device 200 to the gateway 100.

Subsequently, the creation module 122 of the gateway 100 creates a whitelist in which details of communication permitted for each IoT device 200 are designated on the basis of information regarding the communication transmitted by the transmission module 222 (step S104). For example, the creation module 122 of the gateway 100 creates a whitelist in which details of communication permitted for each IoT device 200 are designated on the basis of the NSTO as information regarding normal communication performed by the IoT device 200 transmitted by the transmission module 222.

Thereafter, the setting module 123 of the gateway 100 sets the whitelist created by the creation module 122 (step S105). For example, the setting module 123 sets the gateway 100 to permit only communications within the range described in the whitelist created by the creation module 122. At this time, for example, the setting module 123 of the gateway 100 may notify the IoT device 200 that the created whitelist has been set.

Then, with the whitelist set by the setting module 123, the IoT device 200 is permitted to communicate within the range described in the whitelist (step S106). For example, communication within a range described in a whitelist set by the setting module 123 of the IoT device 200 is permitted, and communication outside the range described in the whitelist is not permitted.

[Effects] The communication control system 1 according to the embodiment is a communication control system including a gateway 100 and an IoT device 200 connected to the gateway 100, in which the gateway 100 includes a request module 121 that requests, from the IoT device 200, information regarding normal communication performed by the IoT device 200, and a creation module 122 that creates a whitelist in which details of communication permitted for each IoT device 200 are designated on the basis of the information regarding normal communication performed by the IoT device 200, which is transmitted from the IoT device 200, and the IoT device 200 includes a transmission module 222 that transmits the information regarding normal communication performed by the IoT device 200 to the gateway 100 in response to a request from the request module 121.

Accordingly, the communication control system 1 enables the gateway 100 to use information regarding normal communication performed by the IoT device 200 to create a whitelist, thereby enabling a third party to verify whether or not access permissions that are inconvenient for the user are being granted.

In the communication control system 1 according to the embodiment, the request module 121 of the gateway 100 requests a Network Secure Transparency Object (N STO) as the information regarding normal communication performed by the IoT device 200.

Accordingly, the communication control system 1 enables the gateway 100 to use the NSTO as information regarding normal communication performed by the IoT device 200 to create a whitelist, thereby enabling a third party to verify whether or not access permissions that are inconvenient for the user are being granted.

In the communication control system 1 according to the embodiment, the gateway 100 further includes a setting module 123 that sets the whitelist created by the creation module 122.

Accordingly, the communication control system 1 enables the gateway 100 to use information regarding normal communication performed by the IoT device 200 to create a whitelist, thereby enabling a third party to verify whether or not access permissions that are inconvenient for the user are being granted.

In the communication control system 1 according to the embodiment, the IoT device 200 further includes a start request module 221 that requests the gateway 100 to start communication, and the request module 121 of the gateway 100 receives a request to start communication from the start request module 221 and requests, from the IoT device 200, the information regarding normal communication performed by the IoT device 200.

Accordingly, the communication control system 1 enables the gateway 100 to use information regarding normal communication performed by the IoT device 200 to create a whitelist, thereby enabling a third party to verify whether or not access permissions that are inconvenient for the user are being granted.

The gateway 100 according to the embodiment includes a request module 121 that requests, from the IoT device 200, information regarding normal communication performed by the IoT device 200, and a creation module 122 that creates a whitelist in which details of communication permitted for each IoT device 200 are designated on the basis of the information regarding normal communication performed by the IoT device 200, which is transmitted from the IoT device 200.

This enables the gateway 100 to use information regarding normal communication performed by the IoT device 200 to create a whitelist, thereby enabling a third party to verify whether or not access permissions that are inconvenient for the user are being granted.

[System Configuration, Etc.] In addition, each component of each device that has been illustrated is functionally conceptual, and is not necessarily physically configured as illustrated. In other words, the specific aspects of distribution and integration of the devices are not limited to those illustrated in the drawings, all or part of the components may be distributed or integrated functionally or physically in desired units depending on various kinds of loads and states of use. For example, all or any part of the processing functions performed by the devices may be achieved by a CPU and programs analyzed and executed by the CPU or achieved as hardware by a wired logic.

Further, among the processes described in the present embodiment, all or some of the processes described as being automatically performed can also be manually performed, or all or some of the processes described as being manually performed can also be performed automatically using a known method. In addition, the processing procedure, the control procedure, specific names, information including various types of data and parameters that are shown in the above document and drawings may be arbitrarily changed unless otherwise described.

[Others] While various embodiments have been described in detail in the present specification with reference to the drawings, a plurality of these embodiments are examples and the present invention is not intended to limit to the plurality of these embodiments. The features described in the present specification can be realized according to various methods, including various modifications and improvements based on the knowledge of those skilled in the art.

In addition, the above-mentioned “module (-er suffix, -or suffix)” can be read as a unit, means, a circuit, or the like. For example, the communication module, the control module, and the storage module can be read as a communication unit, a control unit, and a storage unit, respectively.

### REFERENCE SIGNS LIST

1 Communication control system
100 Gateway
110 Communication module
120 Control module
121 Request module
122 Creation module
123 Setting module
130 Storage module
200 IoT device
210 Communication module
220 Control module
221 Start request module
222 Transmission module
230 Storage module

1. A communication control system comprising a gateway and an IoT device connected to the gateway,
wherein the gateway includes:
a request module configured to request, from the IoT device, information regarding normal communication performed by the IoT device; and
a creation module configured to create a whitelist in which details of communication permitted for each IoT device are designated on a basis of the information regarding normal communication performed by the IoT device, which is transmitted from the IoT device, and
the IoT device includes
a transmission module configured to transmit the information regarding normal communication performed by the IoT device to the gateway in response to a request from the request module.

2. The communication control system according to claim 1, wherein the request module requests a Network Secure Transparency Object (NSTO) as the information regarding normal communication performed by the IoT device.

3. The communication control system according to claim 1, wherein the gateway further includes a setting module configured to set the whitelist created by the creation module.

4. The communication control system according to claim 1, wherein the IoT device further includes
a start request module configured to request the gateway to start communication, and
the request module receives a request to start communication from the start request module and requests, from the IoT device, the information regarding normal communication performed by the IoT device.

5. A gateway comprising:
a request module configured to request, from an IoT device, information regarding normal communication performed by the IoT device; and
a creation module configured to create a whitelist in which details of communication permitted for each IoT device are designated on a basis of the information regarding normal communication performed by the IoT device, which is transmitted from the IoT device.

6. A communication control method executed by a gateway and an IoT device connected to the gateway, the communication control method comprising:
a request step in which the gateway requests, from the IoT device, information regarding normal communication performed by the IoT device;
a transmission step in which the IoT device transmits the information regarding normal communication performed by the IoT device to the gateway in response to a request from the request step; and
a creation step in which the gateway creates a whitelist in which details of communication permitted for each IoT device are designated on a basis of the information regarding normal communication performed by the IoT device, which is transmitted in the transmission step.
